(19) United States
(12) Patent Application Publication
(10) Pub. No.: US 2014/0199022 A1
(43) Pub. Date: Jul. 17, 2014

(54) OPTICAL CONNECTOR WITH HIGH LIGHT-COUPLING EFFICIENCY

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/972,873

(22) Filed: Aug. 21, 2013

(30) Foreign Application Priority Data
Jan. 17, 2013 (TW) 102101728

(51) Int. Cl. G02B 6/42

(52) U.S. Cl. CPC G02B 6/4204
USPC 385/33

(57) ABSTRACT

An optical connector includes a printed circuit board, a photoelectric element positioned on and electrically connected to the printed circuit board, a lens element, and an optical fiber. The lens element defines a cutout having a sidewall and a blind hole in the sidewall. The lens element defines a receiving recess and forms a lens in a bottom surface of the recess. The lens is optically aligned to gather light which is directly reflected from a light-emitting optical fiber inserted in the blind hole. The lens element is positioned on the printed circuit board such that the photoelectric element is received in the recess and aligned with the lens.

### BACKGROUND

1. Technical Field

The present disclosure relates to optical connectors and, particularly, to an optical connector having a high light-coupling efficiency.

2. Description of Related Art

Optical connectors include a printed circuit board, a photoelectric element, a lens element, a jumper, and an optical fiber. The photoelectric element is positioned on and electrically connected to the printed circuit board. The lens element is also positioned on the printed circuit board and includes a first lens aligned with the photoelectric element. The optical fiber is positioned in the jumper and the jumper is engaged with the lens element. The lens element also includes a second lens which is optically coupled with the first lens and is required to be aligned with the optical fiber. However, being limited by engagement precision, the optical fiber may be misaligned from the second lens and degrade light-coupling efficiency.

Therefore, it is desirable to provide an optical connector that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of an optical connector, according to an embodiment.

FIG. 2 is a cross-sectional view taken along a line II-II of FIG. 1.

### DETAILED DESCRIPTION

Embodiments of the present disclosure will be described with reference to the drawings.

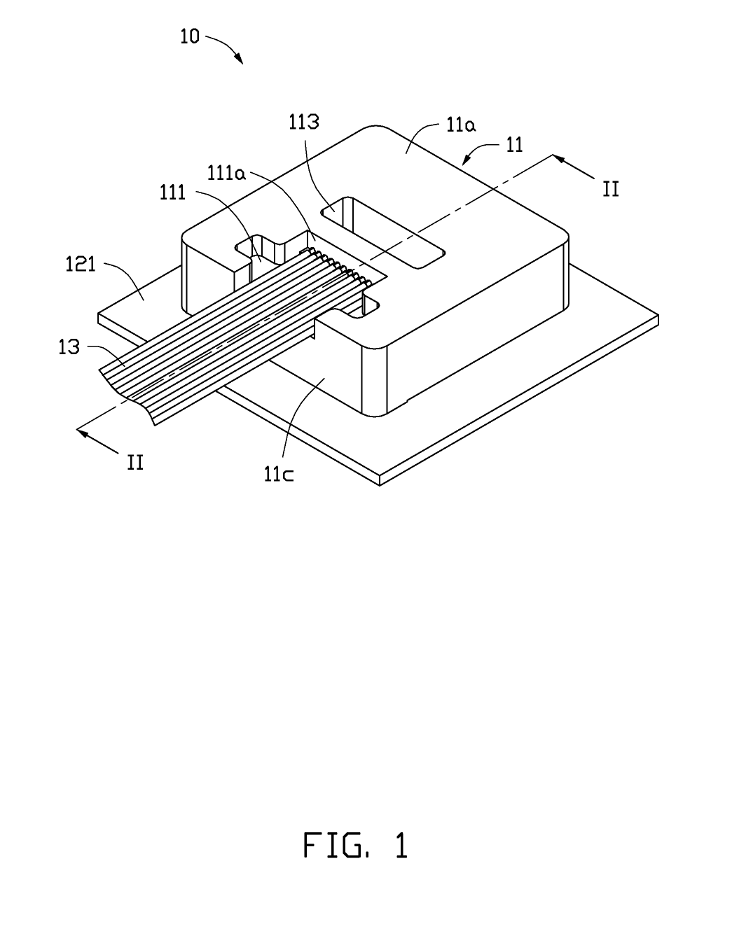

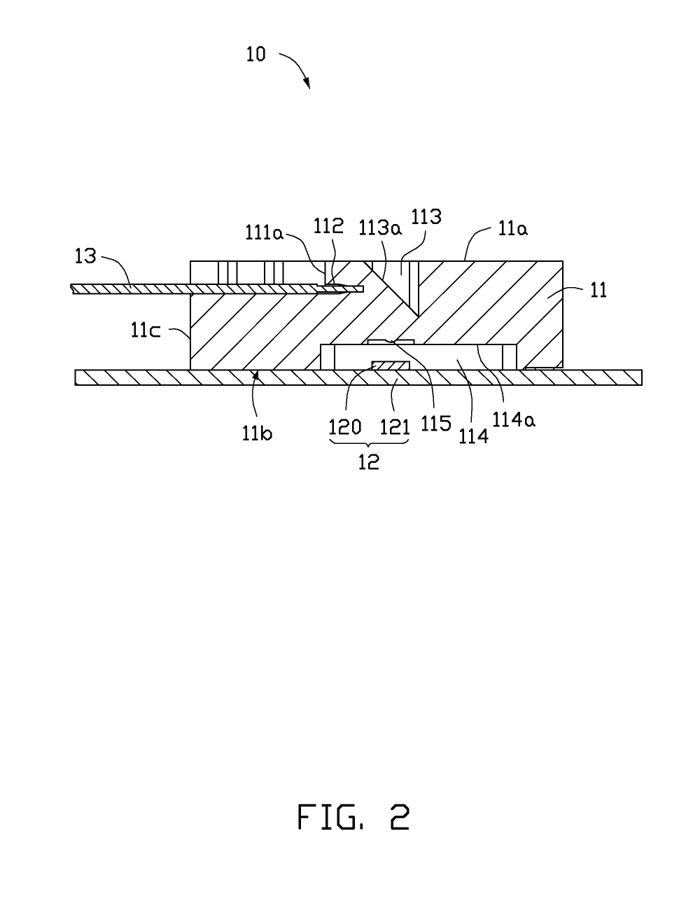

FIGS. 1, 2 show an optical connector 10, according to an embodiment. The optical connector includes a lens element 11, a photoelectric module 12, and a number of optical fibers 13.

The lens element 11 is substantially rectangular and includes an upper surface 11a, a lower surface 11b opposite to the upper surface 11a, and a front surface 11c perpendicularly connecting the upper surface 11a and the lower surface 11b.

The lens element 11 defines a receiving cutout 111 in an intersecting portion of the upper surface 11a and the front surface 11c. The cutout 111 is substantially rectangular and has a sidewall 111a that is substantially parallel with the front surface 11c.

The lens element 11 also defines a number of blind holes 112 in the sidewall 111a, for positioning the optical fibers 13. The blind holes 112 are equidistantly arranged along a line that is substantially parallel with the upper surface 11a.

The lens element 11 defines a slot 113 in the upper surface 11a. A lengthwise direction of the slot 113 is substantially parallel with the sidewall 111a. The slot 113 has a reflective surface 113a that is adjacent to the cutout 111 and slanted about 45 degrees relative to the sidewall 111a. Orthogonal projections of the blind holes 112 fall onto the reflective surface 113a.

The lens element 11 also defines a receiving recess 114 in the lower surface 11b. The recess 114 is substantially rectangular and has a bottom surface 114a.

The lens element 11 also includes a number of lenses 115 formed in the bottom surface 114a. The lenses 115 are equidistantly arranged along a line that is substantially parallel with the front surface 11c. Each lens 115 is optically aligned with light from a blind hole 112 being reflected from the reflective surface 113a. In other embodiments, each lens 15 can be optically aligned with a blind hole 112 by other suitable structures, not being limited by the slot 113.

The photoelectric module 12 includes a number of photoelectric elements 120 and a printed circuit board 121. The photoelectric elements 120 can be light emitters, such as laser diodes or light emitting diodes, or light receivers, such as photo diodes. The photoelectric elements 120 are positioned on and electrically connected to the printed circuit board 121 and equidistantly arranged along a line.

In assembly, the lens element 11 is positioned on the printed circuit board 121 such that the photoelectric elements 120 are received in the recess 114 and each photoelectric element 120 is aligned with one of the lenses 115.

The optical fibers 13 are positioned in the cutout 111 and each optical fiber 13 is simply inserted into one of the blind holes 112 such that each optical fiber 13 is efficiently coupled with one of the photoelectric elements 120 via the reflective surface 113a and one of the lenses 115.

In other embodiments, only one optical fiber 13, one blind hole 112, one lens 115, and one photoelectric element 120 can be employed as needed.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An optical connector, comprising:
a photoelectric module comprising a printed circuit board and a photoelectric element positioned on and electrically connected to the printed circuit board;
a lens element comprising a upper surface, a lower surface opposite to the upper surface, and a front surface perpendicularly connected to the upper surface and the lower surface, the lens element defining a cutout in an intersecting portion of the upper surface and the front surface, the cutout comprising a sidewall that is substantially parallel with the front surface, the lens element defining a positioning blind hole in the sidewall, the lens element defining a receiving recess in the lower surface and forming a lens in a bottom surface of the recess, the lens being optically aligned with the blind hole, the lens element being positioned on the printed circuit board such that the photoelectric element is received in the recess and aligned with the lens; and
an optical fiber positioned in the cutout and inserted into the blind hole to optically couple with the photoelectric element via the lens.

2. The optical connector of claim 1, wherein the photoelectric element is a laser diode or a light emitting diode.

3. The optical connector of claim 1, wherein the photoelectric element is a light receiver.

4. The optical connector of claim 1, wherein the photoelectric element is a photo diode.

5. The optical connector of claim 1, wherein the lens element defines a slot in the upper surface, a lengthwise direction of the slot is substantially parallel with the sidewall, the slot has a reflective surface that is adjacent to the sidewall and slants relative to the sidewall about 45 degrees, the lens is optically aligned with the blind hole by the reflective surface.
